(19) United States
(12) Patent Application Publication
(10) Pub. No.: US 2009/0248300 A1
(43) Pub. Date: Oct. 1, 2009

(54) Methods and Apparatus for Viewing Previously-Recorded Multimedia Content from Original Perspective

(75) Inventors: Gregory A. Dunko, Cary, NC (US); Justin Pierce, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/059,095

(22) Filed: Mar. 31, 2008

(51) Int. Cl. G01C 21/34; G06F 17/00

(52) U.S. Cl. 701/209; 715/202; 701/300; 701/211

(57) ABSTRACT

Methods and apparatus for processing multimedia content are disclosed. In an exemplary method, such as might be implemented a portable multimedia device, stored media data pre-associated with a current location of the multimedia device is retrieved. The retrieved media data is mixed with real-time sensor input collected by the multimedia device to obtain mixed media data, and the mixed media data is rendered at the multimedia device, using, for example, a display device and/or speaker devices. The retrieved media data or the real-time sensor input, or both, may comprise digital audio data, digital video data, or both.

### BACKGROUND

The present invention relates generally to the processing of multimedia content. More specifically, the invention relates to methods and apparatus for mixing previously-recorded multimedia content with real-time sensor data based on the location and/or orientation of the multimedia device.

With the convergence of voice and data communications and multimedia applications, portable communication devices are increasingly likely to support several communication modes as well as a number of multimedia applications. A typical device often includes a camera, a music player, and sound recorder, and may include a global positioning system (GPS) receiver.

Most multimedia applications on portable devices today are directed to simple recording and playback of audio and/or video, and the transfer of recorded multimedia to and from the device. Few applications combine the communications and multimedia processing capabilities of a portable device in a truly synergistic way. Even fewer, if any, exploit the positioning capabilities of today's devices and/or communication networks. This lack of integrated applications will ultimately limit the perceived value of complex portable devices to their users. Thus, techniques are needed for creating richer multimedia experiences for users of portable multimedia devices.

### SUMMARY

Disclosed herein are methods and apparatus for processing multimedia content. In particular, pre-recorded media recorded at a particular location may be combined, according to some embodiments of the invention, with audio and/or video collected in real time by a multimedia device at the same location. In this manner, a device user's real-time media experience may be enhanced, or augmented, with previously recorded media.

Media data, including recorded video and/or audio, may be “tagged” with the location and orientation of the recording device. This information comprises metadata defining the perspective from which the content is captured. Later, media data carrying or associated with this metadata may be viewed normally, e.g., without specific use of the metadata, or may be combined with real-time data according to one or more embodiments of the invention. For instance, a multimedia device user may go to the location where the pre-recorded content was obtained, establish the same location and orientation, and then view the previously generated video content superimposed on or interweaved with the user's current view.

In an exemplary method, such as might be implemented in a portable multimedia device, stored media data associated with a current location of the multimedia device is retrieved. The retrieved media data is mixed with real-time sensor input collected by the multimedia device to obtain mixed media data, and the mixed media data is rendered at the multimedia device, using, for example, a display device and/or speaker devices. The retrieved media data or the real-time sensor input, or both, may comprise digital audio data, digital video data, or both. In some embodiments, a current location of the multimedia device is compared to location metadata corresponding to one or more stored data files, and one of the stored data files is selected and retrieved, based on the comparison, for mixing with the real-time sensor data. The location information may be obtained using a Global Positioning System (GPS) receiver or other positioning technology.

In some embodiments, mixing the stored media data with real-time sensor input comprises mixing video data from the stored media data with video data from the real-time sensor input. In some of these embodiments, the video data from the stored media data is shifted and/or scaled to match the scale and perspective of the real-time video data before mixing. In some embodiments, the opacity of at least a portion of the video data from the stored media data may be adjusted before mixing.

Multimedia devices configured to carry out one or more of the disclosed multimedia processing methods are also disclosed. In some of these embodiments, a current location of the device is compared to location data associated with the stored media data, and an audio output, video output, or both, are provided to direct the user of the multimedia device to the precise location associated with the stored media data. In some of these embodiments, the current orientation of the multimedia device is compared to orientation metadata associated with the stored media data, and audio or video outputs are provided to the user to indicate a required change in orientation of the multimedia device to match the stored media data perspective.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 illustrates a communication system according to one or more embodiments of the present invention.

FIG. 2 illustrates an exemplary method for measuring the location and orientation of a multimedia recording device and associating the location and orientation with stored media data.

FIG. 3 is a logic flow diagram illustrating a method of processing multimedia content according to one or more embodiments of the present invention.

FIG. 4 is a logic flow diagram illustrating an exemplary procedure for retrieving stored media data that is pre-associated with a current location of a multimedia device.

FIG. 5 is a logic flow diagram illustrating another exemplary procedure for retrieving stored media data that is pre-associated with a current location of a multimedia device.

FIG. 6 is a logic flow diagram illustrating an exemplary method for processing and mixing stored video data with real-time device video data.

FIG. 7 is a logic flow diagram illustrating an exemplary method for directing a multimedia device's user to a location and orientation associated with a multimedia file.

FIG. 8 is a block diagram illustrating an exemplary multimedia device

### DETAILED DESCRIPTION

Several embodiments of the present invention involve a portable multimedia device including wireless communication capabilities. Thus, without limiting the inventive methods and techniques disclosed herein to this context, the present invention is generally described below in reference to a wireless telecommunication system providing voice and data services to a mobile multimedia device. Various systems providing voice and data services have been deployed, such as GSM networks (providing circuit-switched communications) and GPRS (providing packet-switched communications); still others are currently under development. These systems may employ any or several of a number of wireless access technologies, such as Time Division Multiple Access (TDMA), Code Division Multiple Access (CDMA), Frequency Division Multiple Access (FDA), Orthogonal Frequency Division Multiple Access (OFDMA), Time Division Duplex (TDD), and Frequency Division Duplex (FDD). The present invention is not limited to any specific type of wireless communication network or access technology. Indeed, those skilled in the art will appreciate that the network configurations discussed herein are only illustrative. The inventive techniques disclosed herein may be applied to “wired” devices accessing conventional voice or data networks, as well as wireless devices. The invention may be practiced with devices accessing voice and/or data networks via wireless local area networks (WLANs) or via one or more of the emerging wide-area wireless data networks, such as those under development by the 3^{rd}-Generation Partnership Project (3GPP).

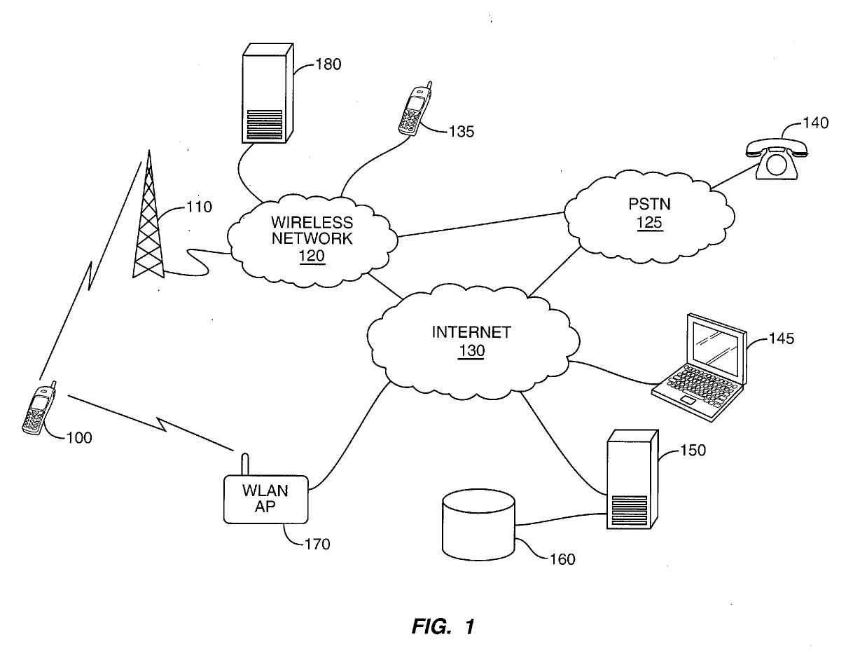

FIG. 1 illustrates an exemplary communication system in which the present invention may be employed. Communication device 100 communicates with other devices through base station 110, which is connected to wireless network 120. Wireless network 120 is in turn connected to the Public Switched Telephone Network (PSTN) 125 and the Internet 130. Wireless device 100 can thus communicate with various other devices, such as wireless device 135, conventional land-line telephone 140, or personal computer 145. In FIG. 1, communication device 100 also has access to media server 150 via the Internet 130; media server 150 may be configured to provide access through Internet 130 to media data stored in storage device 160. Storage device 160 may comprise one or more of a variety of data storage devices, such as disk drives connected to data server 150 or one or more other servers, a Redundant Array of Inexpensive Drives (RAID) system, or the like.

Communication device 100 may be a cordless telephone, cellular telephone, personal digital assistant (PDA), communicator, computer device, or the like, and may be compatible with any of a variety of communications standards, such as the Global System for Mobile Communications (GSM) or one or more of the standards promulgated by 3GPP. Communication device 100 may support various multimedia applications, and may include a digital camera, for still and video images, as well as a digital sound recorder and digital music player application. Communication device 100 may also support various communications-related applications, such as e-mail, text messaging, picture messaging, instant messaging, video conferencing, web browsing, data transfer, and the like.

Communication device 100 may also include a wireless local-area network (WLAN) transceiver configured for communication with WLAN access point 170. WLAN access point 170 is also connected to Internet 130, providing communication device 100 with alternative connectivity to Internet-based resources such as data server 150.

Communication device 100 may also include positioning capability. In some cases, communication device 100 may include a Global Positioning System (GPS) receiver, in which case communication device 100 may be able to autonomously determine its current location. In other cases, communication device 100 may relay measurement data to a mobile-assisted positioning function located in the network in order to determine its location; in some cases, communication device 100 may simply receive positioning information from a network-based positioning function.

Thus, FIG. 1 illustrates a location server 180 connected to wireless network 120. Location server 180 is typically maintained by the operator of wireless network 120, but may be separately administered. The main function of location server 180 is to determine the geographic location of mobile terminals (such as mobile terminal 100) using the wireless network 120. Location information obtained by location server 180 may range from information identifying the cell currently serving mobile terminal 100 to more precise location information obtained using Global Positioning System (GPS) technology.

Other technologies, including triangulation methods exploiting signals transmitted from or received at several base stations, may also be used to obtain location information. Triangulation techniques may include Time Difference of Arrival (TDOA) technology, which utilizes measurements of a mobile's uplink signal at several base stations, or Enhanced-Observed Time Difference (E-OTD) technology, which utilizes measurements taken at the mobile terminal 100 of signals sent from several base stations. GPS-based technologies may include Assisted GPS, which utilizes information about the current status of the GPS satellites derived independently of the mobile terminal 100 to aid in the determination of the terminal's location.

In addition to being capable of measuring or otherwise determining its location, communication device 100 may also be capable of determining its orientation, using one or more built-in sensors. As used herein, “orientation” may refer simply to a direction in which a device is pointed, where the direction may comprise only a compass direction or azimuth (e.g., NNW, or 323°), or may be an azimuth plus an elevation. Orientation may also include a measure of “tilt” or rotation of the device around the direction the device is pointing. Those skilled in the art will appreciate that orientation may be recorded and represented in a number of formats, whether one, two, or three dimensions are measured. A variety of inexpensive electronic sensors are available for determining the orientation of a device, including electronic compasses (e.g., using the KMZ51 or KMZ52 magneto-resistive sensor from Philips Semiconductors), accelerometers (e.g., based on Micro-Electro-Mechanical Systems, or MEMS, such as the ADXL330 3-axis accelerometer from Analog Devices), and gyroscopes (e.g., the ADXRS614 MEMS gyroscope from Analog Devices). The use of orientation detection and/or tilt detection is thus becoming quite common in consumer devices, such as electronic games.

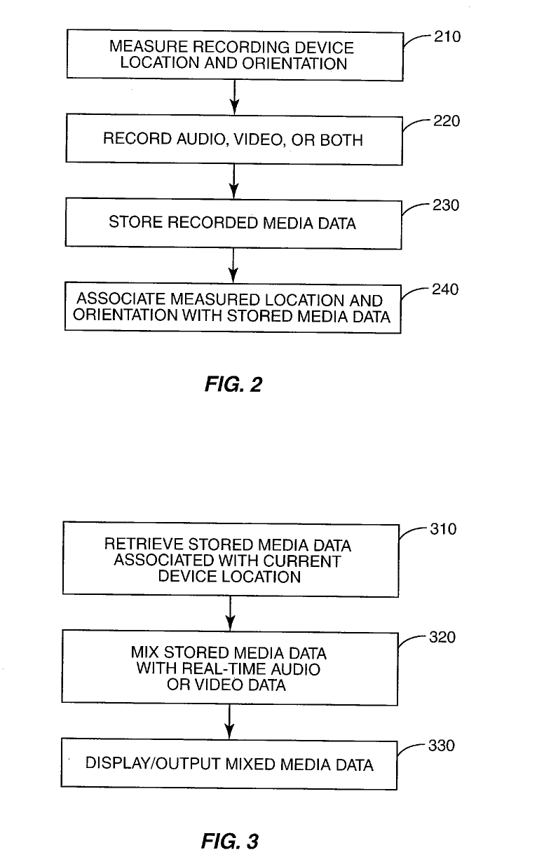

A multimedia device may thus be configured to measure its location and orientation while recording multimedia data, and to save location and orientation information in association with the recorded multimedia file. This is illustrated in the logic flow diagram of FIG. 2, which might be implemented in a consumer device, such as wireless communication device 100, or in a professional-grade multimedia recording system. The process illustrated in FIG. 2 begins at block 210, with the measurement of the recording device's location and orientation. At block 220, audio, video, or both, are recorded, using conventional means, and stored as media data at block 230. At block 240, the measured location and orientation information is stored in association with the stored media data.

The location and orientation information comprises “metadata” corresponding to the recorded media data; this metadata may be stored as part of the corresponding stored media data file, or stored separately and indexed to the stored media data file. Those skilled in the art will appreciate that in some embodiments a single location and orientation are measured and recorded for a given media file, while in other embodiments the location or orientation, or both, may be tracked over the course of the recording operation, with several data points stored in association with the recorded multimedia file.

Multimedia files, whether recorded by an amateur or a professional, for recreational or commercial purposes, may thus be associated with location and/or orientation data indicating the perspective of the recording device during the recording of the multimedia file. At a later time or date, the recorded content may be viewed “normally”, e.g., without specific use of this associated perspective information. Alternatively, the associated perspective may be utilized to enhance the playback of the recorded multimedia file, such as by providing a means to retrieve supplemental information about the recording for the user. For example, a user might travel to the Grand Canyon and capture video looking precisely north at −10 degree tilt from the “South Kaibab” trailhead. During later playback, the rendering multimedia device might utilize this perspective data to retrieve associated information, such as background information regarding the Grand Canyon, or to retrieve other multimedia with similar perspective data.

A third use of the recorded multimedia file with associated perspective data provides an “augmented reality” experience. A multimedia device user at the general location of the original recording may position his device at the same location and perspective, and then overlay the previously generated video content with a current view. For example, the user may be presented with a video of a friend who was previously at the exact same location. In this augmented reality scenario, the display presented to the user might include the real view (e.g., the Grand Canyon as it looks at the present time from the South Kaibab trailhead), plus an overlaid augmented video of his friend at that same point. In addition to or instead of augmenting a video presentation with pre-recorded video data, the current video might be augmented with audio data (so that, for example, the user hears his friend saying, “Whoa, look at that view!” as recorded during the friend's original visit to that location in the Grand Canyon).

Those skilled in the art will appreciate that the methods described above may be applied to commercial content as well as to amateur content. Thus, a multimedia user may be provided with commercial or promotional content that is tagged with metadata based on, for example, the perspective of content capture during the filming of a movie, or the perspective of various fictional characters (the actors) in a particular scene in a movie. This could be done through insertion of location, orientation and direction “tags” or metadata during the filming of a movie. For example, independent of the actual location of the film shot, the content creator (i.e. film director) may be given the option of inserting location data for where the scene is purported to have been shot or made (to account for the fact that often movies are shot at fictional movie sets and not at the actual portrayed location). In another example, a current movie may include a number of scenes that are shot “on location”—for instance, on the Pont Neuf Bridge in Paris. One or more digital video clips from the movie may be associated with perspective information corresponding to the location and orientation of the recording camera (or cameras). Thus, when a user uses her phone at the Pont Neuf bridge, she may be provided with a video clip taken from a location close to her current location. In some cases, the user might simply view the video clip on her device's display. In others, however, the user's multimedia experience may be enhanced by overlaying the video clip with varying levels of opacity on the present reality view.

Thus, a general method for processing multimedia content is illustrated at FIG. 3. At block 310, stored media data associated with a current device location is retrieved by the user's multimedia device. In some cases, the media data may comprise one of several media files stored on the multimedia device itself. In other embodiments, the media data may comprise one of several media files available through a media server, such as media server 150 in FIG. 1, accessible to the multimedia device through a communication network, such as the wireless network 120 and Internet 130 of FIG. 1.

At block 320, the retrieved media data is mixed with real-time audio and/or video data collected by the multimedia device. Thus, as discussed above, audio data from the retrieved media data may be mixed with audio data from a microphone in the multimedia device. This mixed audio data might be played back through a speaker (e.g., through a headset), as shown at block 330, or recorded by the multimedia device for later playback.

Similarly, video data from the retrieved media data may be mixed with real-time video data collected by a video camera in the multimedia device. This mixed video data may be presented in real time to the user using the device's display, as illustrated at block 330, and may in some embodiments be recorded for later viewing. Those skilled in the art will appreciate that the mixed video data might, in some embodiments, be presented to a user via a head- or helmet-mounted display.

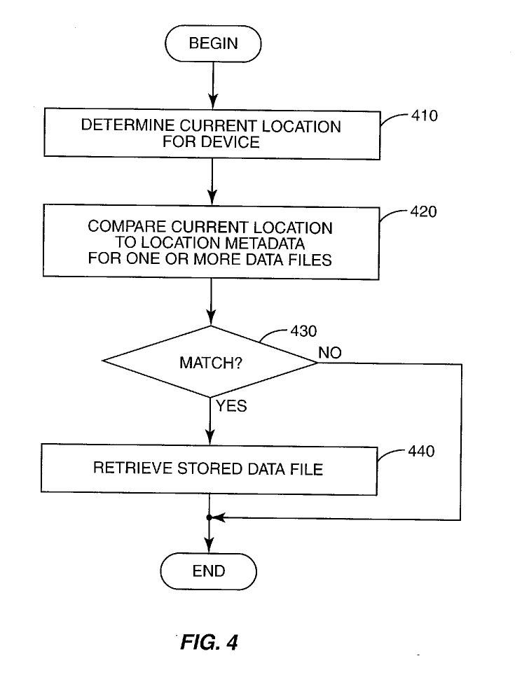

As noted above, the stored media data retrieved for mixing might be but one of several stored media data files. In some embodiments, a particular media data file is selected based on a correspondence between the location and/or orientation associated with the media data file and the current location and/or orientation of the user's multimedia device. A logic flow for one such embodiment is illustrated in FIG. 4.

At block 410, a current location is determined for the user's multimedia device. As was discussed earlier, some multimedia devices may be equipped with GPS technology, so that the devices are capable of determining their locations autonomously. Other multimedia devices may relay on network-based or mobile-assisted positioning technologies, in which case a multimedia device may receive its location from a location server in the network. Although not shown in block 410, a multimedia device may also determine its current orientation, e.g., a compass direction and tilt, to be used in retrieving a multimedia file.

At block 420, the multimedia device's current location is compared to location metadata for one or more stored data files. In embodiments where the multimedia device itself holds the one or more stored data files, the device's location information may be compared to local metadata, whether stored as part of the stored data files or in a separate database. In other embodiments, such as an embodiment where multimedia files are stored on a media server, this step may comprise comparing the device's current location to location metadata for several (perhaps dozens, or hundreds) of files stored at or accessible to a media server.

In any event, if a “match” occurs, as shown at block 430, then the stored data file with the matching location metadata is retrieved, as shown at block 440. In some cases, a “matching” data file may simply be the data file associated with the location metadata most closely corresponding to the device's current location. More typically, however, a data file's location metadata might be deemed to match the device's location only if it falls within a pre-determined threshold distance from the device's location. Those skilled in the art will appreciate that a combination of these two approaches might be used in some embodiments, such that a closest match is selected from two or more data files having location metadata falling within a threshold distance of the device's current location. Those skilled in the art will also appreciate that the matching process may include the comparison of orientation data for the device to orientation metadata for the stored data files.

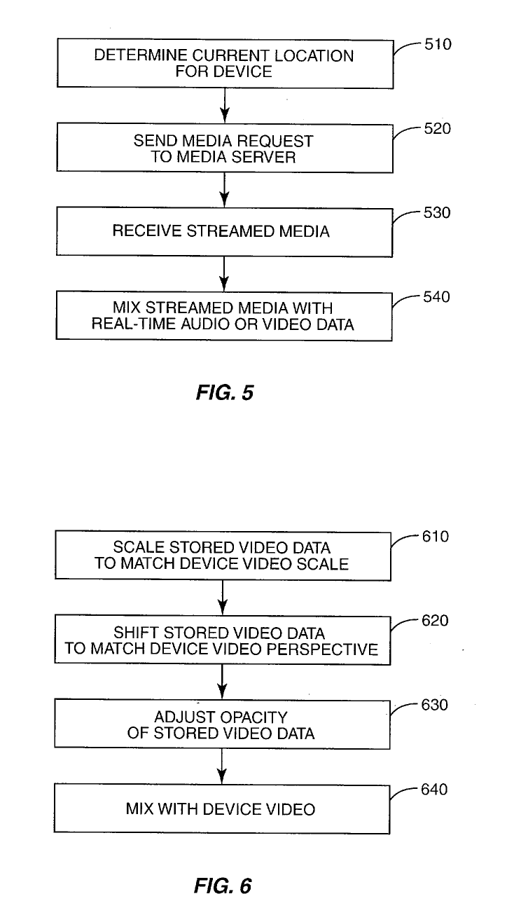

In some cases, as suggested above, the matching process might take place at a media server, remotely from the user multimedia device. In these embodiments, the retrieved media data file may be downloaded in its entirety, for subsequent processing by the user device. Alternatively, the retrieved media data file may be streamed to the user device, using, for example, a well-known streaming protocol such as the Real-Time Streaming Protocol (RTSP). An exemplary procedure for retrieving a streamed media file is illustrated at FIG. 5.

The method of FIG. 5 begins at block 510, where a current location is determined for the device. At block 520, a media request is sent to the media server. In some embodiments, the media request includes one or more parameters indicating the device's location. In other embodiments, the media server may independently retrieve location information for the requesting multimedia device, such as by requesting the device's location from location server 150 in FIG. 1. In either event, the device's location information is used by the media server to select a stored media data file having location metadata matching the device's location. At block 530, the media data file is received by the user device as streamed media. The streamed media is combined with real-time audio or video data collected by the multimedia device at block 540, for display to the user or for recording.

Those skilled in the art will appreciate that mixing retrieved audio data with real-time audio and/or video data collected by the multimedia device is a relatively straightforward process. Thus, in some embodiments, retrieved audio data may simply be summed (e.g., in digital form, using a digital signal processor, or in analog form, using a summing amplifier circuit) with the locally obtained audio data. In some cases, as will be understood by those skilled in the art, one or both sources of audio data may be attenuated or amplified to obtain the proper balance between the sources or to prevent limiting, or “clipping” by the audio processing circuitry. In some embodiments, adjustments to the audio amplitudes may be made automatically, while in others the device user may be provided with controls for adjusting the audio levels, whether independently or together.

Mixing retrieved video data, on the other hand, may be a more elaborate process. In some cases, the retrieved video data may need to be scaled and or shifted (i.e., translated in one or two dimensions) so that it may be superimposed on the locally collected video data at the proper scale and perspective. A general procedure for processing stored video data to match the scale and perspective of the device's local video data is thus illustrated at FIG. 6.

At block 610, the stored video data is scaled to match the device's video scale. Several different techniques may be used to determine whether, and if so, by how much, the stored video data must be scaled. For instance, metadata associated with the stored video data may indicate a magnification, or “zoom” factor used when recording the original video image. If the original recording was scaled after recording, but before retrieval by the multimedia device, the metadata may reflect an intermediate scaling factor. The magnification factor for the stored video may be compared to the magnification factor employed by the multimedia device for the real-time video to determine how much scaling of the stored video data is required. The actual scaling may be performed by conventional digital video scaling techniques; those skilled in the art will appreciate that this scaling may be performed by the multimedia device in some embodiments, or by a media server, before delivery to the multimedia device, in others. Those skilled in the art will also appreciate that the scaling process may require that the scaled video be cropped, especially when the stored video is scaled up.

In other embodiments, the correct scaling factor to be used may be determined by analysis of the stored video data, the real-time video data, or both. For example, a prominent feature in each of the stored video data and real-time data may be detected, measured, and compared to determine a scaling factor for scaling the stored video. Certain structural features, for example, such as a building, street light, or park bench, may prove particularly suitable for this approach, as these structural features should remain relatively stationary and constant over several video frames. In some embodiments, the stored video data may be pre-processed to detect suitable features for use in scaling analysis. In these embodiments, metadata associated with the stored video data may identify such a feature, providing dimensional data, outline data, or other data locating the feature in one or more stored video data frames. This metadata may be used by the multimedia device to aid in identifying the corresponding feature or features in the locally derived video data.

Similar techniques may be used to shift the stored video data to match the device video perspective, as shown at block 620. In some embodiments, a comparison of the device's current orientation to orientation metadata associated with the stored video data will provide an adequate basis for calculating the translation needed to align the stored video data. (However, those skilled in the art will appreciate that the magnification factors discussed above may also be required to calculate the proper translation.) In many cases, especially if some of the advanced blending features discussed below are employed, small differences between the device's current orientation and the orientation associated with the stored video data can be corrected with a simple translation, in one or more dimensions, based on this calculation. In other cases, feature matching, such as was described above with respect to block 610, may also be used to obtain more precise matching of the stored video data perspective to the device's current view. Those skilled in the art will appreciate that the scaling and translation operations may be performed jointly, especially when both are based on feature matching.

Simple superposition of stored video data on real-time video data may result in mixed video that appears blurry, out-of-focus, or simply confusing. Thus, several techniques may be employed to blend the video sources. One of these techniques is shown at block 630, where the opacity of the stored video data is adjusted. The stored video data may be adjusted so that it appears semi-transparent, relative to the locally collected video data. When superimposed on the local video, features of the stored video data may thus appear as “ghostly” images superimposed on the “real” features of the stored video data. Those skilled in the art will appreciate that the level of opacity may be fixed by the multimedia device in some embodiments. In others, an opacity setting may be included in the metadata associated with the stored video data, and used by the multimedia device to adjust the opacity during the mixing operation at block 640. In still others, an opacity setting may be derived by analyzing the stored video data.

Those skilled in the art will appreciate that other video processing techniques may be used to further enhance the mixing, at block 640, of stored video data with real-time video collected by the multimedia device. For instance, prominent static features (e.g., the bridge in the examples given earlier) may be removed from the stored video data entirely, leaving only moving features, such as people or vehicles. Removing these prominent static features will generally make the scaling and translation operations described above less critical. In some embodiments, one or more static features may be removed from the stored video data in a pre-processing operation or just before mixing. In others, the presence of static features may be determined by analyzing the stored video data and the local video. Such a process may include comparing the two video sources to identify image features that are shared between the sources and thus more likely to be static.

The importance of precise correspondence between the multimedia device's location and orientation and the location and orientation associated with the stored video data will vary from scenario to scenario. For example, if one or both of the video images are dominated by far-off landscape, such as a view of the Grand Canyon, then very precise correspondence in absolute location (e.g., to within one or two feet) is not critical, since a difference of even 10 or 20 meters may make little appreciable difference in the scale of image features. On the other hand, precise orientation may be more critical in such scenarios than in an indoor scenario, or one dominated by features in the near field.

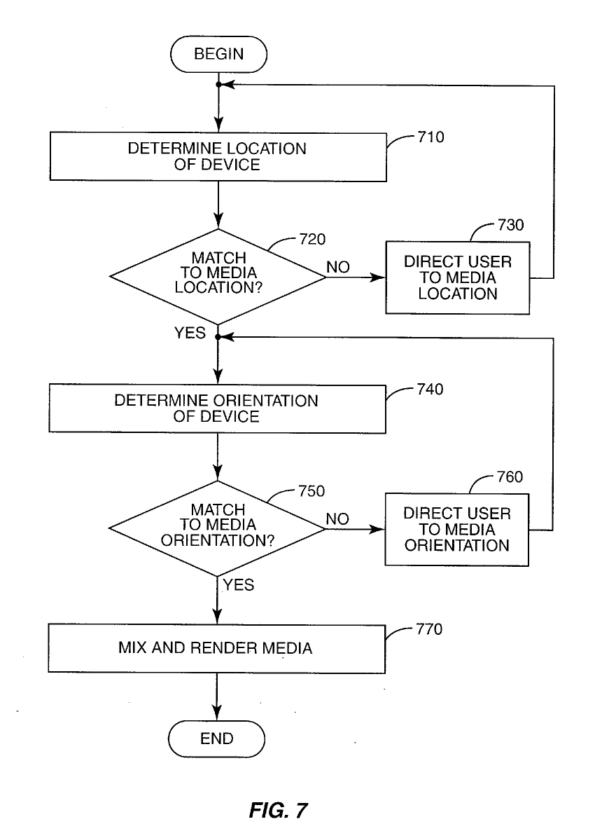

In any event, some embodiments of the present invention may provide guidance to the multimedia device's user to aid in proper positioning of the device. An exemplary method for providing such guidance is illustrated in FIG. 7.

At block 710, a location for the device is determined, using, for example, any of the techniques described above. At block 720, the device's location is compared to the location metadata associated with the stored media data to determine whether it “matches.” Note that this match may require a greater degree of precision than was required for the matching of FIG. 4, which was performed for the purpose of retrieving a file associated with a current location. However, like the process illustrated in FIG. 4, this matching process may comprise determining whether the current location of the multimedia device falls within a pre-determined distance of the location metadata for the stored media data. The pre-determined distance may be fixed by the device, or may vary with the stored media data file, in which case the pre-determined distance may be included in metadata associated with the file.

If the device's location does not adequately match the location associated with the stored media data, then the user is directed towards the media location, as shown at block 730. This guidance may be provided using an audio signal, a video signal rendered on the device's display, or both. The location of the device is re-evaluated, at block 710, and again compared to the media location. This process repeats until the correspondence between the device's actual location and the location indicated by the location metadata is deemed sufficiently close.

At block 740 the device's orientation is determined, using, for example, an electronic compass, a tilt sensor, or both. The device's orientation is compared to the orientation metadata associated with the stored media data to determine whether it matches, as indicated at block 750. Again, this matching process may comprise determining whether the current orientation of the multimedia device falls within a pre-determined range of orientations. As with the location matching process, this pre-determined range may be fixed by the device, or may vary with the stored media data file, in which case the pre-determined range may be included in metadata associated with the file.

If the device's orientation does not adequately match the orientation associated with the stored media data, then the user is directed to adjust the orientation of the device towards the media orientation, as shown at block 760. Again, this guidance may be provided using an audio signal, a video signal rendered on the device's display, or both, the audio and/or video signal indicating a required change in orientation of the multimedia device. The orientation of the device is re-evaluated, at block 740, and again compared to the media orientation. This process repeats until the correspondence between the device's actual orientation and the orientation indicated by the media data file's metadata is deemed sufficiently close. When the location and orientation are both “matched” to the stored media data file, mixing and rendering of the media may commence, as indicated at block 770.

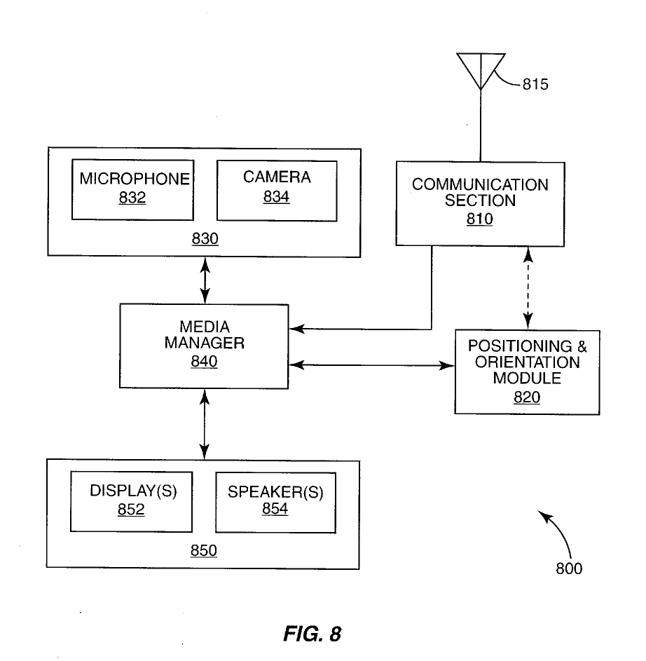

Those skilled in the art will appreciate that the methods illustrated in FIGS. 2-7, as well as variants thereof, may be implemented at any of a variety of multimedia devices, including the various communication devices pictured in FIG. 1. An exemplary multimedia device 800 is pictured in FIG. 8. Those skilled in the art will recognize that the pictured multimedia device 800 may comprise a mobile telephone, a personal digital assistance (PDA) device with mobile telephone capabilities, a laptop computer, or other device with multimedia capabilities. Multimedia device 800 includes a communication section 810 configured to communicate with one or more wireless networks via antenna 815. Communication section 810 may be configured for operation with one or more wide-area networks, such as a W-CDMA network, or a wireless local area network (W-LAN), such as an IEEE 802.11 network. Communication section 810 may further be configured for operation with a wired network, via, for example, an Ethernet interface (not shown).

Multimedia device 800 further comprises a positioning & orientation module 820. In some embodiments, positioning & orientation module 820 may include a complete GPS receiver capable of autonomously determining the device's location. In other embodiments, a GPS receiver with less than full functionality may be included, for taking measurements of GPS signals and reporting the measurements to a network-based system for determination of the mobile device's location. In still others, positioning & orientation module 820 may be configured to measure time differences between received cellular signals (or other terrestrial signals) for calculation of the device's location. In some cases this calculation may be performed by the positioning & orientation module 820; in others, the results of the measurements are transmitted to a network-based system, using communication section 810, for final determination of the location.

Positioning & orientation module 820 may also include one or more orientation sensors, such as an electronic compass, a gyroscope or other device for sensing tilt, and the like. One or more of these sensors may be a MEMS device, as discussed above. Multimedia device also includes one or more real-time sensors 830, including microphone 832 and camera 834. The positioning & orientation module 820 and the real-time sensors 830 are coupled to media manager 840, which, inter alia, manages recording and/or output of sensor data, mixing and other processing of real-time sensor data and pre-recorded media data. Media manager 840 is coupled to output section 850 for rendering of real-time, recorded, or mixed media; output section 850 includes one or more display devices 852 and speakers 854.

In some embodiments of the present invention, memory manager 840 and/or other processing logic included in communication device 800 is configured to carry out one or more of the methods described above. In particular, media manager 840 may be configured to retrieve stored media data pre-associated with a current location of the multimedia device, mix the stored media data with real-time sensor input collected from the one or more real-time sensors 820, to obtain mixed data, and render the mixed media data, using the output section 850.

In some embodiments, media manager 840 may be configured to compare a current location for the multimedia device 800, obtained from positioning & orientation module 820, with location metadata corresponding to one or more stored data files, and to retrieve one of the stored data files, based on the comparison, for mixing with real-time sensor data. In these embodiments, the one or more stored data files may be stored in non-volatile memory (not shown) in multimedia device 800. In other embodiments, media manager may be configured to send a media request, using communication section 810, to a remote media server, and to receive stored media data in response to the request. In some embodiments, the media request may contain location information for multimedia device 800. The stored media data received in response to the request may include a complete media data file, or may comprise streamed media. In either case, the media manager 840 is configured to mix the received stored media data with real-time sensor data from microphone 832 and/or camera 834 to produce mixed media for rendering at display 852 and/or speaker 854. Note that display 852 and\or speaker 854 may be “integral” parts of device 800 or may be external accessories.

Those skilled in the art will appreciate that the various functions of multimedia device 800 may be implemented with customized or off-the-shelf hardware, general purpose or custom processors, or some combination. Accordingly, each of the described processing blocks may in some embodiments directly correspond to one or more commercially available or custom microprocessors, microcontrollers, or digital signal processors. In other embodiments, however, two or more of the processing blocks or functional elements of device 800 may be implemented on a single processor, while functions of other blocks are split between two or more processors. One or more of the functional blocks pictured in FIG. 8 may also include one or more memory devices containing software, firmware, and data, including stored media data files, for processing multimedia in accordance with one or more embodiments of the present invention. Thus, these memory devices may include, but are not limited to, the following types of devices: cache, ROM, PROM, EPROM, EEPROM, flash, SRAM, and DRAM. Those skilled in the art will further appreciate that functional blocks and details not necessary for an understanding of an invention have been omitted from the drawings and discussion herein.

The skilled practitioner should thus appreciate that the present invention broadly provides methods and apparatus for processing multimedia content, including the mixing of real-time audio and/or video data with pre-recorded media. The present invention may, of course, be carried out in other specific ways than those herein set forth without departing from the scope and essential characteristics of the invention. Thus, the present invention is not limited to the features and advantages detailed in the foregoing description, nor is it limited by the accompanying drawings. Indeed, the present invention is limited only by the following claims, and their legal equivalents.

1. A method of processing multimedia content, comprising:
retrieving stored media data associated with a current location of a multimedia device;
mixing the stored media data with real-time sensor input collected by the multimedia device to obtain mixed media data; and
rendering the mixed media data at the multimedia device.

2. The method of claim 1, wherein retrieving the stored media data comprises:
determining the current location of the multimedia device;
comparing the current location to location metadata corresponding to one or more stored data files; and
retrieving one of the stored data files, based on the comparison, to obtain the stored media data.

3. The method of claim 1, wherein retrieving the stored media data comprises:
determining the current location of the multimedia device;
sending a media request, the request comprising an indication of the current location and receiving the stored media data in response to the request.

4. The method of claim 3, wherein receiving the stored media data in response to the request comprises receiving streamed media, and wherein mixing the stored media data with real-time sensor input comprises mixing the streamed media with the real-time sensor input.

5. The method of claim 1, wherein mixing the stored media data with real-time sensor input comprises mixing audio data from the stored media data with audio data from the real-time sensor input.

6. The method of claim 1, wherein mixing the stored media data with real-time sensor input comprises mixing video data from the stored media data with video data from the real-time sensor input.

7. The method of claim 6, further comprising scaling and shifting the video data from the stored media data to match the scale and perspective of the video data from the real-time sensor input before mixing the video data from the stored media data with video data from the real-time sensor input.

8. The method of claim 6, wherein mixing video data from the stored media data with video data from the real-time sensor input comprises adjusting the opacity of at least a portion of the video data from the stored media data before mixing.

9. The method of claim 1, further comprising comparing the current location of the multimedia device to precise location data associated with the stored media data and providing an audio output, video output, or both, directing the user of the multimedia device to a precise location.

10. The method of claim 1, further comprising matching a current orientation of the multimedia device to orientation data associated with the stored media data before mixing the stored media data with the real-time sensor input and rendering the mixed media data.

11. The method of claim 10, further comprising comparing a first orientation of the multimedia device to the orientation data and providing an audio output, a video output, or both, indicating a required change in orientation of the multimedia device.

12. A multimedia device comprising
one or more real-time sensors,
an output section, and
a media manager configured to:
retrieve stored media data pre-associated with a current location of the multimedia device;
mix the stored media data with real-time sensor input collected from the one or more real-time sensors, to obtain mixed data; and
render the mixed media data, using the output section.

13. The multimedia device of claim 12, further comprising a positioning module configured to determine the current location of the multimedia device, wherein the media manager is further configured to:
compare the current location to location metadata corresponding to one or more stored data files; and
retrieve one of the stored data files, based on the comparison, to obtain the stored media data.

14. The multimedia device of claim 12, further comprising a positioning module configured to determine the current location of the multimedia device and a communication section, wherein the media manager is further configured to:
send a media request via the communication section, the request comprising an indication of the current location; and
receive, via the communication section, the stored media data in response to the request.

15. The multimedia device of claim 14, wherein the media manager is configured to receive streamed media in response to the request and to mix the stored media data with real-time sensor input by mixing the streamed media with the real-time sensor input.

16. The multimedia device of claim 12, wherein the media manager is configured to mix the stored media data with real-time sensor input by mixing video data from the stored media data with video data from the real-time sensor input.

17. The multimedia device of claim 16, wherein the media manager is configured to scale and shift the video data from the stored media data to match the scale and perspective of the video data from the real-time sensor input before mixing the video data from the stored media data with video data from the real-time sensor input.

18. The multimedia device of claim 16, wherein the media manager is configured to adjust the opacity of at least a portion of the video data from the stored media data before mixing the video data from the stored media data with video data from the real-time sensor input.

19. The multimedia device of claim 12, wherein the media manager is further configured to compare the current location of the multimedia device to precise location data associated with the stored media data and to provide, via the output section, an audio output, video output, or both, directing the user of the multimedia device to a precise location.

20. The multimedia device of claim 12, wherein the media manager is further configured to match a current orientation of the multimedia device to orientation data associated with the stored media data before mixing the stored media data with the real-time sensor input and rendering the mixed media data.

21. The multimedia device of claim 20, wherein the media manager is further configured to compare a first orientation of the multimedia device to the orientation data and to provide, via the output section, an audio output, a video output, or both, indicating a required change in orientation of the multimedia device.
